(19) United States
(12) Patent Application Publication
(10) Pub. No.: US 2012/0200926 A1
(43) Pub. Date: Aug. 9, 2012

(54) OPTICAL FILTER, OPTICAL FILTER MODULE, ANALYSIS DEVICE, AND OPTICAL DEVICE

(75) Inventor: Tomonori MATSUSHITA, Chino (JP)

(73) Assignee: Seiko Epson Corporation, Tokyo (JP)

(21) Appl. No.: 13/365,555

(22) Filed: Feb. 3, 2012

(30) Foreign Application Priority Data
Feb. 4, 2011 (JP) 2011-022449

(51) Int. Cl. G02B 26/00; G02B 5/28

(52) U.S. Cl. 359/578; 359/589

(57) ABSTRACT

An optical filter includes a first substrate, a second substrate, a first reflective film that is disposed on the first substrate, a second reflective film that is disposed on the second substrate, first and second fixed electrodes that are disposed on the first substrate at positions located at the periphery of the first reflective film in plan view, and first and second variable electrodes that are disposed on the second substrate and face the first and second fixed electrodes. Slit portions of the second variable electrode are formed such that the first and second variable electrodes have a center symmetrical structure with the reflective film as its center.

### BACKGROUND

1. Technical Field

The present invention relates to an optical filter, an optical filter module, an analysis device, and an optical device.

2. Related Art

An interference filter having a variable transmitted wavelength is known (JP-A-11-142752). As illustrated in FIG. 3 of JP-A-11-142752, the interference filter includes: one pair of substrates maintained to be parallel to each other; one pair of multi-layer films (reflective films) that are formed so as to face each other on the one pair of substrates and have a gap formed therebetween; and one pair of electrostatic driving electrodes that are used for varying the width of the gap. Such a variable-wavelength interference filter can change the center wavelength of transmitted light by generating an electrostatic attractive force in accordance with a voltage applied to the electrostatic driving electrodes so as to vary the width of the gap.

However, in such a variable wavelength interference filter, it is difficult to control the gap with high accuracy due to a variation in the driving voltage that is caused by noise or the like.

A method may be considered in which the gap is controlled with high accuracy by decreasing the sensitivity of the electrodes. However, in such a case, the lead-out portion of an inner electrode portion overlaps an outer electrode portion, and an electrostatic force is generated in that portion which causes a non-uniform force, whereby there is a problem in that the accuracy of controlling the gap decreases.

### SUMMARY

An advantage of some aspects of the invention is that it provides an optical filter, an optical filter module, an analysis device, and an optical device capable of controlling the width of the gap with high accuracy.

### Application Example 1

This application example is directed to an optical filter including: a first substrate; a second substrate that faces the first substrate; a first reflective film that is disposed on the first substrate; a second reflective film that is disposed on the second substrate and faces the first reflective film; a first fixed electrode that is disposed on the first substrate and is formed at the periphery of the first reflective film in plan view; a second fixed electrode that is disposed on the first substrate and is formed at the periphery of the first fixed electrode in plan view; a lead-out wiring that is connected to the first fixed electrode and extends away from the first reflective film; a first variable electrode that is disposed on the second substrate and faces the first fixed electrode; and a second variable electrode that is disposed on the second substrate and faces the second fixed electrode. The second variable electrode includes a plurality of slit portions, and the second variable electrode has a center-symmetrical structure with the reflective film as its center, and the lead-out wiring passes through the slit portion in plan view.

According to such a configuration, the first variable electrode that is disposed on the second substrate and faces the first fixed electrode and the second variable electrode that is disposed on the second substrate and faces the second fixed electrode are included, and the second variable electrode includes a plurality of slit portions and has a center-symmetrical structure with the reflective film as its center. Accordingly, the membrane stress acting on the second variable electrode and the electrostatic force at the time of driving are symmetrical with the reflective film as its center, and therefore, the bending of the reflective films, the bent state, and the like can be prevented, whereby the gap can be controlled with high accuracy.

### Application Example 2

In the optical filter according to the above-described application example, it is preferable that a third variable electrode is disposed at an outer-circumferential side of the second variable electrode, the third variable electrode has center symmetry with the reflective film as its center, and the number of slit portions of the third variable electrode is the same as or more than the number of slit portions of the second variable electrode.

According to such a configuration, the third variable electrode and the third fixed electrode are disposed, and the third variable electrode has a center-symmetrical structure with the reflective film. Accordingly, the accuracy of the gap can be improved by increasing the number of electrodes. In addition, since the variable electrode has a center-symmetrical structure with the reflective film as its center, the bending of the reflective films, the bent state, and the like can be prevented, whereby the gap can be controlled with higher accuracy.

### Application Example 3

In the optical filter according to the above-described application example, it is preferable that the first fixed electrode and the second fixed electrode are electrically independent of each other, and the first variable electrode and the second variable electrode are electrically connected to each other through a connection portion.

According to such a configuration, the second variable electrode is disposed at the outer-circumferential side of the first variable electrode, and the slit portions are included in the second variable electrode, whereby the lead-out wiring of the first fixed electrode can be disposed to not face the second variable electrode. Therefore, no unnecessary electrostatic force is generated, whereby the gap can be controlled with high accuracy.

### Application Example 4

This application example is directed to an optical filter module including: the above-described optical filter; and a light receiving element that receives light transmitted through the optical filter.

According to such a configuration, since the optical filter has a gap that can be controlled with high accuracy, an optical filter module having satisfactory characteristics can be provided.

### Application Example 5

This application example is directed to an analysis device including the above-described optical filter.

According to such a configuration, since the optical filter has a gap that can be controlled with high accuracy, an analysis device having satisfactory characteristics can be provided.

### Application Example 6

This application example is directed to an optical device including the above-described optical filter.

According to such a configuration, since the optical filter has a gap that can be controlled with high accuracy, an optical device having satisfactory characteristics can be provided.

### BRIEF DESCRIPTION OF THE DRAWINGS

Embodiments of the invention will be described with reference to the accompanying drawings, wherein like numbers reference like elements.

FIG. 1 is a cross-sectional view illustrating a state of an optical filter according to an embodiment of the invention in which a voltage is not applied thereto.

FIG. 2 is a cross-sectional view illustrating a state of the optical filter shown in FIG. 1 in which a voltage is applied thereto.

FIG. 3A is a plan view of a lower electrode, and FIG. 3B is a plan view of an upper electrode.

FIG. 4 is a plan view of a state, in which the lower electrode and the upper electrode overlap each other, viewed from a second substrate side.

FIG. 5 is a block diagram of an application voltage control system of the optical filter.

FIG. 6 is a characteristic diagram illustrating an example of voltage table data.

FIG. 7 is a characteristic diagram illustrating the relation between a gap between first and second reflective films of the optical filter and a transmitted peak wavelength thereof.

FIG. 8 is a characteristic diagram illustrating data of an example relating to an electric potential difference, the gap, and the variable wavelength shown in FIG. 7.

FIG. 9 is a characteristic diagram illustrating the relation between an application voltage and the transmitted peak wavelength shown in FIG. 7.

FIG. 10 is a block diagram of an analysis device according to another embodiment of the invention.

FIG. 11 is a flowchart illustrating a spectrum measuring operation of the device shown in FIG. 10.

FIG. 12 is a block diagram of an optical device according to yet another embodiment of the invention.

### DESCRIPTION OF EXEMPLARY EMBODIMENTS

Hereinafter, preferred embodiments of the invention will be described in detail. The embodiments described below are not for the purpose of limiting the scope of the invention defined by the appended claims, and all the configurations described in the embodiments are not essential to the invention.

### 1. Optical Filter

### 1.1. Filter Unit of Optical Filter

### 1.1.1. Overview of Filter Unit

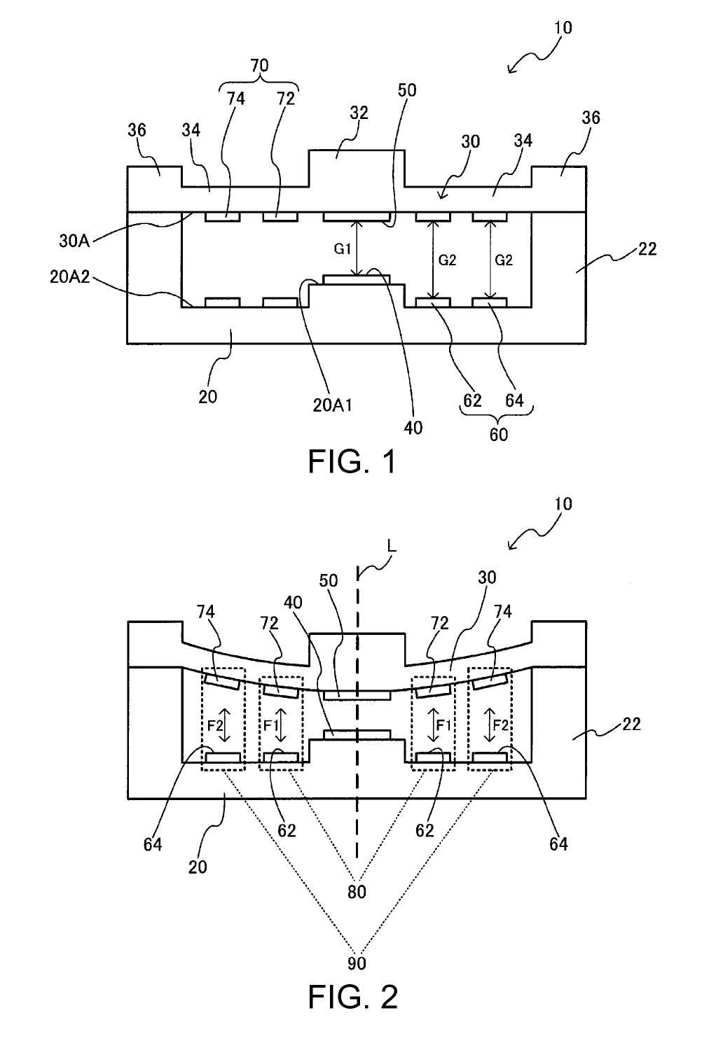

FIG. 1 is a cross-sectional view illustrating a state of an optical filter 10 according to this embodiment in which a voltage is not applied thereto, and FIG. 2 is a cross-sectional view of a state in which a voltage is applied thereto. The optical filter 10 shown in FIGS. 1 and 2 includes a first substrate 20 and a second substrate 30 that faces the first substrate 20. In this embodiment, although the first substrate 20 is configured as a fixed substrate, and the second substrate 30 is configured as a movable substrate or a diaphragm, either or both of the substrates may be configured to be movable.

In this embodiment, a support portion 22 is formed for example, integrally with the first substrate 20, which supports the second substrate 30 so as to be movable. The support portion 22 may be part of the second substrate 30 or may be formed separately from the first and second substrates 20 and 30.

The first and second substrates 20 and 30, for example, are formed from various kinds of glass such as soda glass, crystalline glass, quartz glass, lead glass, potassium glass, borosilicate glass, and non-alkali glass, quartz crystal, or the like. Among these, as a composition material of the substrates 20 and 30, for example, glass containing alkali metal such as sodium (Na) or potassium (K) is preferable. By forming the substrates 20 and 30 by using such a glass, the adhesiveness of reflective films 40 and 50 or electrodes 60 and 70 to be described later or the bonding strength between the substrates can be improved. The two substrates 20 and 30 are integrally formed by being bonded to each other through surface-activated bonding, for example, using plasma polymerized film or the like. Each one of the first and second substrates 20 and 30, for example, is formed in the shape of a square of which one side is 10 mm long, and the maximum diameter of a portion serving as a diaphragm, for example, is 5 mm.

The first substrate 20 is formed by processing a glass base material, for example, formed to be 500 μm thick through etching. A first reflective film 40 having, for example, a circular shape is formed on a first opposing face 20A1 of the first substrate 20, which is located at the center of the opposing faces of the first substrate 20 that face the second substrate 30. Similarly, the second substrate 30 is formed by processing a glass base material, for example having a thickness of 200 μm through etching. A second reflective film 50, which faces the first reflective film 40 and has, for example, a circular shape, is formed at the center position of the opposing face 30A of the second substrate 30 that faces the first substrate 20.

In addition, each one of the first and second reflective films 40 and 50, for example, is formed in the shape of a circle having a diameter of about 3 mm. The first and second reflective films 40 and 50 are reflective films respectively formed by a AgC single layer and can be formed on the first and second substrates 20 and 30 by using a technique such as sputtering. The film thickness dimension of the AgC single layer reflective film, for example, is formed to be 0.03 μm. In this embodiment, although an example is shown in which the AgC single layer reflective films, which can spectrally disperse the entire region of visible light, are used as the first and second reflective films 40 and 50, the reflective films are not limited thereto. Thus, for example, a dielectric multi-layer film acquired by stacking laminated films of TiO₂ and SiO₂ may be used, which has transmittance of light spectrally dispersed higher than that of the AgC single layer reflective film and a narrow half value width of transmittance so as to have good resolving power although it has a narrow wavelength band that can be spectrally dispersed.

In addition, anti-reflection films (AR), which are not shown in the figure, may be formed at positions corresponding to the first and second reflective films 40 and 50 on the faces of the first and second substrates 20 and 30 that are located on the side opposite to the opposing faces 20A1, 20A2, and 30A. These anti-reflection films are respectively formed by alternately stacking a low-refractive index film and a high-refractive index film, decrease the reflectivity of visible light on the interface of the first and second substrates 20 and 30, and increase the transmittance of the visible light.

The first and second reflective films 40 and 50 are arranged so as to face each other through a first gap G1 in the state shown in FIG. 1, in which a voltage is not applied. In addition, in this embodiment, although the first reflective film 40 is configured as a fixed mirror, and the second reflective film 50 is configured as a movable mirror, in accordance with the embodiments of the above-described first and second substrates 20 and 30, either or both of the first and second reflective films 40 and 50 may be configured to be movable.

At a position located at the periphery of the first reflective film 40 in plan view, on a second opposing face 20A2 located on the periphery of the first opposing face 20A1 of the first substrate 20, for example, a lower electrode 60 is formed. Similarly, on the opposing face 30A of the second substrate 30, an upper electrode 70 is disposed so as to face the lower electrode 60. The lower electrode 60 and the upper electrode 70 are arranged so as to face each other through a second gap G2. In addition, the front faces of the lower and upper electrodes 60 and 70 may be respectively coated with an insulating film.

The lower electrode 60 is divided into at least K (here, K is an integer equal to or more than 2) segment electrodes that are electrically independent of one another, and, in this embodiment, the first and second fixed electrodes 62 and 64 are included as an example of K=2.

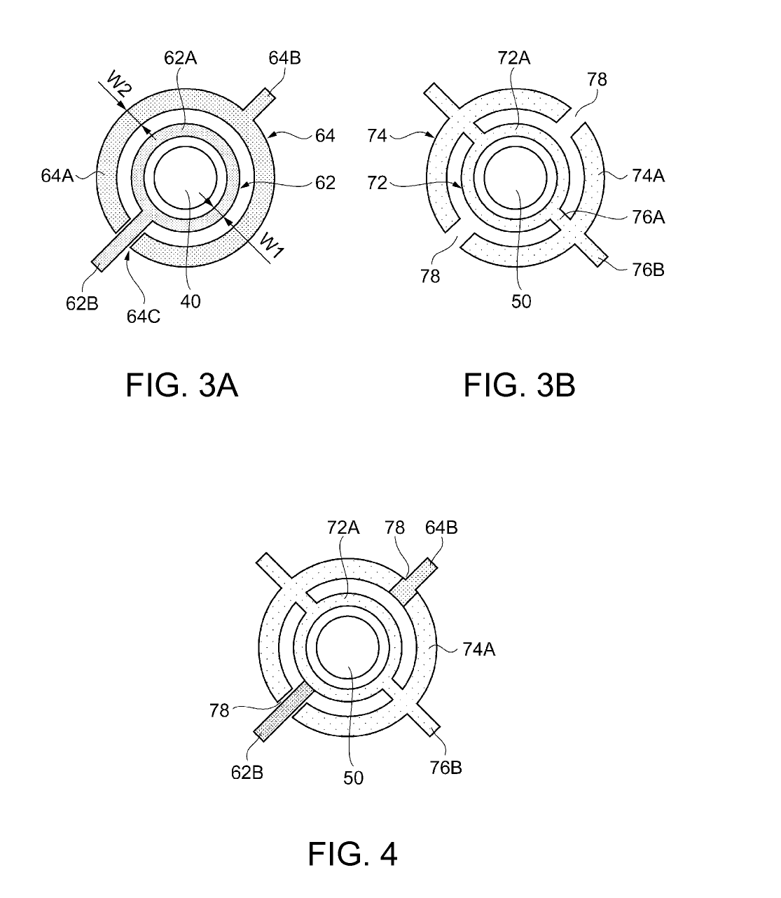

In other words, K segment electrodes can be respectively set to different voltages, and the upper electrode 70 is a common electrode having the same electric potential. In addition, the upper electrode 70 is divided into a first variable electrode 72 and a second variable electrode 74. The first variable electrode 72 and the second variable electrode 74 may not be configured as common electrodes having the same electric potential, and a structure may be employed in which the first variable electrode 72 and the second variable electrode 74 are electrically independent of each other (can be independently controlled). For example, the first variable electrode 72 and the second variable electrode 74 may have a structure as shown in FIG. 3B. In addition, the structure of the lower electrode 60 and the upper electrode 70 may be configured such that an electric potential difference between the first fixed electrode 62 and the first variable electrode 72 and an electric potential difference between the second fixed electrode 64 and the second variable electrode 74 can be independently controlled. Furthermore, in a case where K≧3, the relation between the first fixed electrode 62 and the second fixed electrode 64 described below can be applied to two arbitrary segment electrodes that are adjacent to each other.

According to the optical filter 10 having such a structure, in both the first and second substrates 20 and 30, an area in which the reflective films (the first and second reflective films 40 and 50) are formed and an area in which the electrodes (the lower and upper electrodes 60 and 70) are formed are mutually different areas in plan view, whereby the reflective film and the electrode do not overlap each other (unlike JP-A-11-142752). Accordingly, even in a case where at least one (the second substrate 30 in this embodiment) of the first and second substrates 20 and 30 is configured as a movable substrate, the reflective film and the electrode do not overlap each other, and accordingly, the ease of bending the movable substrate can be secured. In addition, (and again unlike JP-A-11-142752), no reflective film is formed on the lower and upper electrodes 60 and 70, and accordingly, even in a case where the optical filter 10 is used as a transmission-type or reflection-type variable wavelength interference filter, the lower and upper electrodes 60 and 70 are not restricted to transparent electrodes. In addition, even in a case where transparent electrodes are used, the transmission characteristic is affected, and accordingly, by not forming any reflective film on the lower and upper electrodes 60 and 70, a desired transmission characteristic of the optical filter 10 as a transmission-type variable wavelength interference filter is acquired.

In addition, according to this optical filter 10, electrostatic attractive forces denoted by arrows act between opposing electrodes as shown in FIG. 2 by applying a common voltage (for example, the ground voltage) to the upper electrode 70 arranged at the periphery of the second reflective film 50 in plan view and applying independent voltages to the K segment electrodes that configure the lower electrode 60 arranged at the periphery of the first reflective film 40 in plan view, whereby the first gap G1 between the first and second reflective films 40 and 50 is changed to be smaller than the initial gap.

In other words, as shown in FIG. 2 illustrating the optical filter 10 in a state in which a voltage is applied, a first variable gap driving unit (electrostatic actuator) 80 that is configured by the first fixed electrode 62 and the upper electrode 70 facing the first fixed electrode 62 and a second variable gap driving unit (electrostatic actuator) 90 that is configured by the second fixed electrode 64 and the upper electrode 70 that faces the second fixed electrode 64 are independently driven.

By including a plurality of (K) independent variable gap driving units 80 and 90 that are arranged only at the peripheries of the first and second reflective films 40 and 50 in plan view and changing two parameters including the magnitudes of voltages applied to K segment electrodes and the number of segment electrodes selected for the application of voltages out of the K segment electrodes, the size of the gap between the first and second reflective films 40 and 50 is controlled.

By using only the type of a voltage as a parameter (as in JP-A-11-142752), it is difficult to achieve a large gap movable range and low sensitivity for a voltage variation due to noise or the like altogether. However, as shown in this embodiment, by adding a parameter that is the number of electrodes and applying the application voltage ranges that are the same as those in a case where a control operation is performed by using only the voltages to individual segment electrodes, it is possible to perform delicate gap adjustment by generating an electrostatic attractive force that is more delicately adjusted within the large gap movable range.

Here, it is assumed that the maximum value of the application voltage is Vmax, and the gap is changed in N levels. In a case where the lower electrode 60 is not divided into a plurality of sub electrodes, it is necessary to assign the maximum voltage Vmax by dividing it into N parts. At this time, it is assumed that the minimum value of the voltage change amount between mutually different application voltages is ΔV1min. On the other hand, in this embodiment, the application voltages applied to the K segment may be assigned by dividing the maximum voltage Vmax on the average (N/K). At this time, it is assumed that the minimum value of the voltage change amount between mutually different voltages applied to the same segment electrode out of the K segment elements is ΔVkmin. In such a case, it is apparent that the relation of ΔV1min<ΔVkmin is satisfied.

In a case where the minimum voltage change amount ΔVkmin of a large value can be secured, when the application voltages applied to the K first and second fixed electrodes 62 and 64 change more or less due to the noise depending on a power variation, an environmental variation, or the like, the gap variation decreases. In other words, the sensitivity for noise is low, in other words, the voltage sensitivity is low. Accordingly, gap control can be performed with high accuracy, and therefore, the feedback control of a gap is not necessarily needed (unlike in the case disclosed in JP-A-11-142752). In addition, even in a case where the gap is controlled to be fed back, the sensitivity for the noise is low, and accordingly, a stable state can be acquired for a short period.

In this embodiment, in order to secure the bending property of the second substrate 30 as the movable substrate, as shown in FIG. 1, the area in which the upper electrode 70 is formed is formed as a thin portion 34, for example, having a thickness dimension of about 50 μm. This thin portion 34 is formed to be thinner than a thick portion 32 of the area in which the second reflective film 50 is arranged, and a thick portion 36 that is brought into contact with the support portion 22. In other words, in the second substrate 30, the opposing face 30A on which the second reflective film 50 and the upper electrode 70 are formed is a flat face, the thick portion 32 is formed in a first area in which the second reflective film 50 is arranged, and the thin portion 34 is formed in a second area in which the upper electrode 70 is formed. Accordingly, by securing the bending property in the thin portion 34 and configuring the thick portion 32 not to be easily bent, the gap can be changed while maintaining the degree of flatness of the second reflective film 50.

In addition, in this embodiment, although each one of the plurality of (K) independent variable gap driving units is configured by the electrostatic actuator formed from one pair of electrodes, at least one of them may be configured by another type of actuator such as a piezoelectric element. However, the electrostatic actuator that provides a suction force in a non-contact manner has little interference between a plurality of the variable gap driving units and is appropriate for controlling the gap with high accuracy. In contrast to this, in a case where, for example, two piezoelectric elements are arranged between the first and second substrates 20 and 30, one piezoelectric element that is not driven interferes with a gap change that is made by the other piezoelectric element that is driven and the like, thereby an adverse effect occurs in the type in which the plurality of variable gap driving units are independently driven. From that point, it is preferable that the plurality of variable gap driving units are configured by electrostatic actuators.

### 1.1.2. Lower Electrode (Fixed Electrode)

FIG. 3A is a plan view of the lower electrode, and FIG. 3B is a plan view of the upper electrode.

The K segment electrodes configuring the lower electrode 60, as shown in FIG. 3A, can be arranged in the shape of concentric rings with respect to the center of the first reflective film 40. In other words, the first fixed electrode 62 includes a first ring-shaped electrode portion 62A, the second fixed electrode 64 includes a second ring-shaped electrode portion 64A on the outer side of the first ring-shaped electrode portion 62A, and the ring-shaped electrode portions 62A and 64A are formed in the shape of concentric rings with respect to the first reflective film. Here, the “ring-shaped” or “ring shape” is not limited to an endless ring shape but includes a non-continuous ring shape and is a term that is not limited to a circular ring but includes a rectangular ring, a polygonal ring, and the like.

Accordingly, as shown in FIG. 2, the first fixed electrode 62 and the second fixed electrode 64 are arranged to be line-symmetrical with respect to the center line L of the first reflective film 40. Therefore, the electrostatic attractive forces F1 and F2 acting between the lower and upper electrodes 60 and 70 at the time of applying a voltage act to be line-symmetrical with respect to the center line L of the first reflective film 40, whereby the parallelism between the first and second reflective films 40 and 50 increases.

In addition, as shown in FIG. 3A, the ring width W2 of the second fixed electrode 64 can be configured to be larger than the ring width W1 of the first fixed electrode 62 (W2>W1). The reason for this is that the electrostatic attractive force is in proportional to the electrode area, and the electrostatic attractive force F2 generated by the second fixed electrode 64 is acquired to be stronger than the electrostatic attractive force F1 generated by the first fixed electrode 62. Described in more detail, the second fixed electrode 64 disposed on the outer side is disposed closer to the support portion 22 serving as a hinge portion than the first fixed electrode 62. Accordingly, the second fixed electrode 64 needs to generate a strong electrostatic attractive force F2 in resistance against the resistant force at the support portion 22. The second fixed electrode 64 disposed on the outer side has a diameter larger than the first fixed electrode 62 disposed on the inner side, and the area of the second fixed electrode 64 is larger than that of the first fixed electrode 62 even in a case where width W1=width W2. Accordingly, although it may be configured such that width W1=width W2, by increasing the ring width W2, the area is increased further so as to be able to generate a strong electrostatic attractive force F2.

Here, a first lead-out wiring 62B is connected to the first ring-shaped electrode portion 62A of the first fixed electrode 62, and a second lead-out wiring 64B is connected to the second ring-shaped electrode portion 64A of the second fixed electrode 64. These first and second lead-out wirings 62B and 64B are formed to extend, for example, from the center of the first reflective film 40 in a radial direction. In addition, a slit portion 64C that forms the second ring-shaped electrode portion 64A of the second fixed electrode 64 to be discontinuous is provided. The first lead-out wiring 62B extending from the first fixed electrode 62 disposed on the inner side is led out to the outer side of the second fixed electrode 64 through the slit portion 64C formed in the second fixed electrode 64 disposed on the outer side.

In a case where the first and second fixed electrodes 62 and 64 are configured as the ring-shaped electrode portions 62A and 64A, the drawing-out path of the first lead-out wiring 62B of the first fixed electrode 62 disposed on the inner side can be easily secured by using the slit portion 64C formed in the second fixed electrode 64 disposed on the outer side.

### 1.1.3. Upper Electrode (Variable Electrode)

The upper electrode 70 arranged in the second substrate 30 may be formed in an area including the area of the second substrate 30 that faces the lower electrode 60 (the first and second fixed electrodes 62 and 64) formed in the first substrate 20. In a case where the upper electrode 70 is configured as a common electrode to which the same voltage is set, for example, an electrode occupying an entirety of the face of the second substrate may be used.

Instead of this, as this embodiment, the upper electrode 70 arranged in the second substrate 30 that displaces with respect to the first substrate 20, similarly to the lower electrode 60, maybe configured by K segment electrodes. These K segment electrodes may be also arranged in the shape of concentric rings with respect to the center of the second reflective film 50. In such a case, the electrode area formed in the second substrate 30 that is movable is decreased to a requisite minimum, and accordingly, the rigidity of the second substrate 30 decreases, thereby the ease of bending can be secured.

The K segment electrodes configuring the upper electrode 70, as shown in FIGS. 1, 2, and 3B, may include the first variable electrode 72 and the second variable electrode 74. The first variable electrode 72 includes a first ring-shaped variable electrode portion 72A, the second variable electrode 74 includes a second ring-shaped variable electrode portion 74A on the outer side of the first ring-shaped variable electrode portion 72A, and the ring-shaped variable electrode portions 72A and 74A are formed in the shape of concentric rings with respect to the second reflective film. Here, the “concentric ring shape” represents the same as that for the lower electrode 60. The first variable electrode 72 faces the first fixed electrode 62, and the second variable electrode 74 faces the second fixed electrode 64. Accordingly, in this embodiment, the ring width (the same as the ring width W2 of the second fixed electrode 64) of the second variable electrode 74 is larger than the ring width (the same as the ring width W1 of the first fixed electrode 62) of the first variable electrode 72.

Here, at a place facing the first lead-out wiring 62B, the slit portion 78 is inserted into the second ring-shaped variable electrode portion 74A of the second variable electrode 74. Similarly, at a place facing the second lead-out wiring 64B, the slit portion 78 is inserted into the second ring-shaped variable electrode portion 74A of the second variable electrode 74. Here, the shape of the slit portion 78 inserted into the second variable electrode 74 is configured so as to have a center-symmetrical structure with the second reflective film 50 as its center. Accordingly, when a voltage is not applied, the membrane stress of the electrode that is generated in the second substrate is center-symmetrical with the reflective film as its center, and it is possible to acquire anti-bending of the reflective film and a high degree of parallelism. On the other hand, when a voltage is applied, the electrostatic force is not generated in the lead-out wiring, and the electrostatic force is generated only in places that are center-symmetrical with the reflective film as the center, and accordingly, it is possible to acquire anti-bending of the reflective film and a high degree of parallelism.

In addition, the third and fourth lead-out wirings 76A and 76B connected to the first and second ring-shaped variable electrode portions 72A and 74A has a symmetrical structure with respect to the center of the second reflective film 50.

Furthermore, the first variable electrode 72 and the second variable electrode 74 may be electrically connected to each other and are set to the same electric potential. In such a case, for example, the third and fourth lead-out wirings 76A and 76B are formed to extend, for example, from the center of the second reflective film 50 in a radial direction. The third and fourth lead-out wirings 76A and 76B are electrically connected to both the first variable electrode 72 disposed on the inner side and the second variable electrode 74 disposed on the outer side. In addition, although the first and second variable electrodes 72 and 74 are configured as the common electrode and may be connected though one lead-out wiring, by configuring a plurality of the lead-out wirings, the wiring resistance decreases, whereby the charging/discharging speed of the common electrode can be increased. Furthermore, in a case of a structure in which the first and second variable electrodes 72 and 74 are electrically independent from each other, a lead-out wiring is formed in each one of the electrodes.

### 1.1.4. Overlapping Area of Lower and Upper Electrodes

FIG. 4 illustrates an overlapping state of the lower and upper electrodes 60 and 70 according to this embodiment in plan view viewed from the second substrate 30 side. In FIG. 4, since the first and second fixed electrodes 62 and 64 face the first and second variable electrodes 72 and 74, the lower electrode 60 located on the lower side does not appear in plan view viewed from the second substrate 30 side. Only the first and second lead-out wirings 62B and 64B of the lower electrode 60 located on the lower side appears in plan view viewed from the second substrate 30 side.

In this embodiment, as shown in FIGS. 3A and 3B, since the second variable electrode 74 disposed on the outer side out of the upper electrodes 70 includes the slit portion 78, the electrostatic attractive force F2 (see FIG. 2) that is based on a voltage applied to the second variable electrode 74 does not act in the area of the slit portion 78. Since the slit portion 78 is located to be center-symmetrical, the area in which the electrostatic force acts is also center-symmetrical. Accordingly, the driving of the actuator can be controlled with high accuracy based on the electrostatic force.

### 1.2. Voltage Control System of Optical Filter

### 1.2.1. Overview of Blocks of Application Voltage Control System

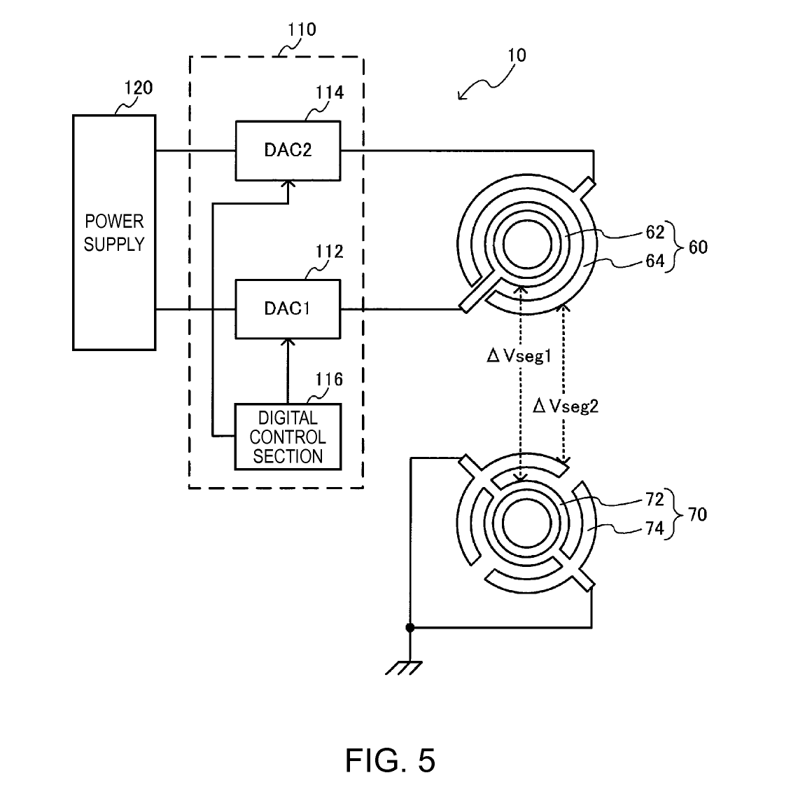

FIG. 5 is a block diagram of an application voltage control system of the optical filter 10. As shown in FIG. 5, the optical filter 10 includes an electric potential difference control unit 110 that controls an electric potential difference between the lower electrode 60 and the upper electrode 70. In this embodiment, since the upper electrodes 70 (the first and second variable electrodes 72 and 74) as common electrodes are fixed to a constant common voltage, for example, the ground voltage (0 V), the electric potential difference control unit 110 controls an inner-circumferential side electric potential difference ΔVseg1 and an outer-circumferential side electric potential difference ΔVseg2 between the first and second fixed electrodes 62 and 64 and the upper electrode 70 by changing the application voltages applied to the first and second fixed electrodes 62 and 64 that are K segment electrodes configuring the lower electrode 60. In addition, a common voltage other than the ground voltage may be applied to the upper electrodes 70, and, in such a case, the electric potential difference control unit 110 may control the application/no-application of the common voltage to the upper electrode 70.

As shown in FIG. 5, the electric potential difference control unit 110 includes: a first electrode driving section connected to the first fixed electrode 62, for example, a first digital-to-analog converter (DAC 1) 112; a second electrode driving section connected to the second fixed electrode 64, for example, a second digital-to-analog converter (DAC 2) 114; and a digital control section 116 that controls the first and second electrode driving sections, for example, in a digital manner. A voltage is supplied from a power supply 120 to the first and second digital-to-analog converters 112 and 114. The first and second digital-to-analog converters 112 and 114 receive the supply of a voltage from the power supply 120 and output an analog voltage corresponding to a digital value output from the digital control section 116. As the power supply 120, although a power supply that is equipped in an analysis device or an optical device in which the optical filter 10 is mounted, a power supply dedicated to the optical filter 10 may be used.

### 1.2.2. Method of Driving Optical Filter

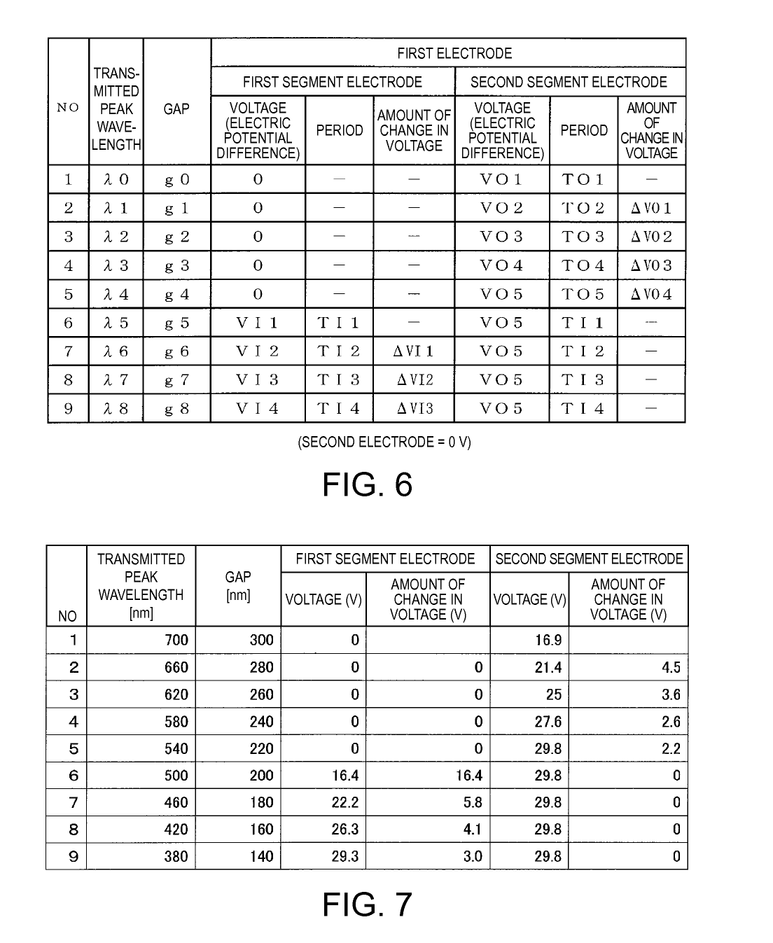

FIG. 6 is a characteristic diagram illustrating an example of voltage table data as source data used for the control operation of the digital control section 116 shown in FIG. 5. This voltage table data may be disposed in the digital control section 116 or may be equipped in an analysis device or an optical device in which the optical filter 10 is mounted.

FIG. 6 represents an example of a case where N=9 as the voltage table dada used for changing the gap between the first and second reflective films 40 and 50 in a total of N levels by sequentially applying voltages to K first and second fixed electrodes 62 and 64. In addition, in FIG. 6, a case where the electric potential differences between both the first and second fixed electrodes 62 and 64 and the upper electrode 70 are 0 V is not included in the gap variable range of N levels. FIG. 6 represents a case where a voltage value other than the voltage value (0 V) of the common voltage applied to the upper electrode 70 is applied to at least one of the first and second fixed electrodes 62 and 64. However, the case where the electric potentials between both the first and second fixed electrodes 62 and 64 and the upper electrode 70 are zero may be defined as a case where the transmitted peak wavelength is the maximum.

### 1.2.3. Example of Electric Potential Difference, Gap, and Variable Wavelength

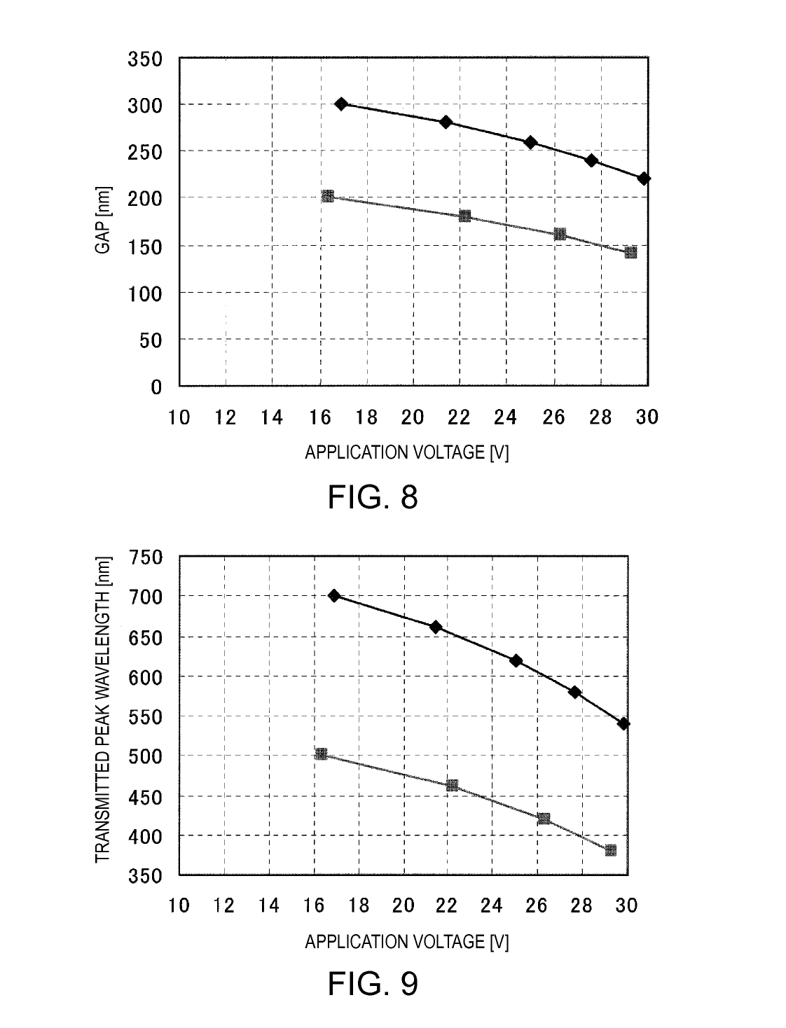

FIG. 7 is a characteristic diagram illustrating data of the embodiment of the electric potential difference, the gap, and the variable wavelength shown in FIG. 6. Data numbers 1 to 9 illustrated in FIG. 7 are the same as data numbers 1 to 9 shown in FIG. 6. FIG. 8 is a characteristic diagram illustrating the relation between the application voltage and the gap shown in FIG. 7. FIG. 9 is a characteristic diagram illustrating the relation between the application voltage and the transmitted peak wavelength shown in FIG. 7.

As shown in FIG. 7, in order to change the transmitted peak wavelength from the maximum wavelength λ0=700 nm to the minimum wavelength λ8=380 nm of the transmitted peak wavelength of 9 levels, the first gap G1 between the first and second reflective films 40 and 50 is changed to 9 levels from the maximum gap g0=300 nm to the minimum gap g8=140 nm (see FIG. 8 as well). In correspondence with this, the transmitted peak wavelength is changed to 9 levels of the maximum wavelength λ0 to the minimum wavelength λ8 (see FIG. 9 as well). In addition, as shown in FIG. 7, by setting 9-level gaps g0 to g8 from the maximum gap g0 to the minimum gap g8 to be equally spaced (=20 nm), the 9-level wavelengths λ0 to λ8 from the maximum wavelength λ0 to the minimum wavelength λ8 are equally spaced (=40 nm) as well. By changing the size of the first gap G1 between the first and second reflective films so as to be sequentially narrowed by a predetermined amount, the transmitted peak wavelength is shortened by a predetermined value each time.

The electric potential difference control unit 110 sequentially sets the outer-circumferential side electric potential difference Δseg2 to VO1=16.9 V, VO2=21.4 V, VO3=25 V, VO4=27. 6 V, and VO5=29.8 V, and, in the state in which VO5=29.8 V is maintained, the inner-circumferential side electric potential difference ΔVseg1 is sequentially set to VI1=16.4 V, VI2=22.2 V, VI3=26.3 V, and VI4=29. 3 V.

In addition, the size of the first gap G1 between the first and second reflective films 40 and 50 is influenced by the electrostatic attractive force F1 that is based on the inner-circumferential side electric potential difference ΔVseg1 more than the electrostatic attractive force F2 that is based on the outer-circumferential side electric potential difference ΔVseg2. Accordingly, even in a case where, after ΔVseg1 is changed first, and the outer-circumferential side electric potential difference ΔVseg2 is changed with the inner-circumferential side electric potential difference ΔVseg1 maintained to a constant value, the electrostatic attractive force F1 according to the inner-circumferential side electric potential difference ΔVseg1 is dominant, and the gap between the first and second reflective films 40 and 50 does not change in accordance with the outer-circumferential side electric potential difference ΔVseg2. Thus, in this embodiment, after the outer-circumferential side electric potential difference ΔVseg2 is changed first, the inner-circumferential side electric potential difference ΔVseg1 is changed with the outer-circumferential side electric potential difference ΔVseg2 maintained to a constant value.

The electric potential difference control unit 110, after the outer-circumferential side electric potential difference ΔVseg2 arrives at the outer-circumferential maximum electric potential difference VO5, maintains the outer-circumferential side electric potential difference ΔVseg2 to the outer-circumferential maximum electric potential difference VO5 and changes the inner-circumferential side electric potential difference ΔVseg1. Accordingly, a gap change from the first gap G1 set by the outer-circumferential side maximum electric potential difference VO5 can be made by one step in accordance with the application of the inner-circumferential side electric potential difference ΔVseg1. In addition, after the inner-circumferential side electric potential difference ΔVseg1 is applied, since the outer-circumferential side maximum electric potential difference VO5 has already been reached, the outer-circumferential side electric potential difference ΔVseg2 does not need to be changed further. Accordingly, when the outer-circumferential side electric potential difference ΔVseg2 is changed, the adverse effect of the dominance electrostatic attractive force F2 according to the inner-circumferential side electric potential difference ΔVseg1 does not occur.

When the electric potential difference control unit 110 sets the inner-circumferential side electric potential difference ΔVseg1 to an inner-circumferential side maximum electric potential difference VI4, the first gap G1 between the first and second reflective films 40 and 50 is set to the minimum gap g8. The outer-circumferential side maximum electric potential difference VO5 and the inner-circumferential side maximum electric potential difference VI4 may be configured to be substantially the same in a range not exceeding the maximum voltage Vmax supplied to the electric potential difference control unit 110. In this embodiment, from the power supply 120 shown in FIG. 5, for example, the maximum voltage Vmax=30 V is supplied to the electric potential difference control unit 110. At this time, outer-circumferential side maximum electric potential difference VO5 is set to 29.8 V not exceeding the maximum voltage Vmax (30 V), and the inner-circumferential side maximum electric potential difference VI4 is set to 29.3 V not exceeding the maximum voltage Vmax (30 V).

In the case of FIG. 7, although the outer-circumferential side maximum electric potential difference VO5 and the inner-circumferential side maximum electric potential difference VI4 has a minute difference of 0.5 V therebetween, they can be regarded as substantially the same. This minute difference is a result of the design in which equal-spaced transmitted peak wavelengths are acquired in the full scale (see FIGS. 8 and 9) in the range not exceeding the maximum voltage Vmax (30 V) for the inner-circumferential side electric potential difference ΔVseg1 and the outer-circumferential side electric potential difference ΔVseg2. Although configuring the outer-circumferential side maximum electric potential difference VO5 and the inner-circumferential side maximum electric potential difference VI4 to match precisely each other can be realized by adjusting the area ratio of the first and second fixed electrodes 62 and 64, there is no sufficient necessity for such precise matching. In addition, according to the driving method of this embodiment, by configuring the outer-circumferential side maximum electric potential difference VO5 and the inner-circumferential side maximum electric potential difference VI4 to be substantially the same, as described with reference to FIG. 3B, there is an advantage of generating a uniform electrostatic attractive force on the approximately whole circumference of the second variable electrode 74 disposed on the outer side.

### 2. Modified Example of Optical Filter

In the above-described optical filter, although the electrostatic actuator is configured by the first fixed electrode and the second fixed electrode and the first and second variable electrodes facing them, a third fixed electrode and a third variable electrode that face the outer-circumferential sides of the second fixed electrode and the second variable electrode may be disposed.

In such a case, the third variable electrode is center-symmetrical with the reflective film as its center, and the number of the slit portions of the third variable electrode is configured to be the same as the number of slit portions of the second variable electrode or more than the number of the slit portions of the second variable electrode.

Accordingly, when no voltage is applied, the membrane stress of the electrode generated in the second substrate has center symmetry with the reflective film as its center, and anti-bending of the reflective film and high parallelism can be acquired. In addition, when a voltage is applied, no electrostatic force is generated in the lead-out wiring, and the electrostatic force is generated only in places having center symmetry with the reflective film as its center, and accordingly, anti-bending of the reflective film and high parallelism can be acquired.

In addition, even in a case where a fourth fixed electrode and a fourth variable electrode are disposed on the outer-circumferential side of the third fixed electrode and the third variable electrode, similar advantages can be acquired.

### 3. Analysis Device

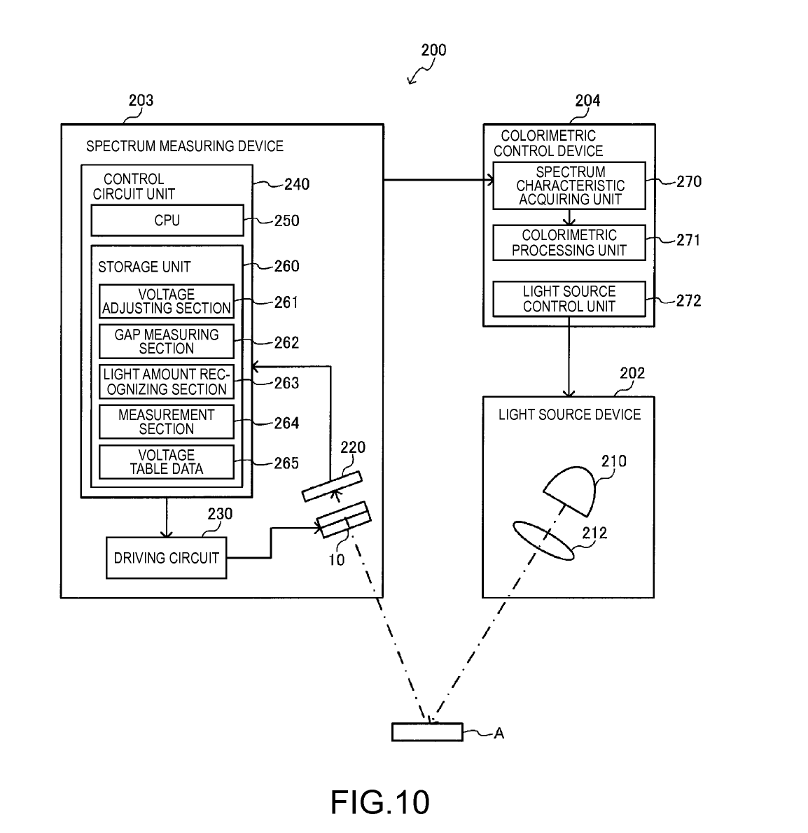

FIG. 10 is a block diagram illustrating a schematic configuration of a colorimetric apparatus as an example of an analysis device according to an embodiment of the invention.

As shown in FIG. 10, the colorimetric apparatus 200 includes a light source device 202, a spectrum measuring device 203, and a colorimetric control device 204. This colorimetric apparatus 200 emits, for example, white light from the light source device 202 toward a test target A, and allows test target light that is light reflected by the test target A to be incident to the spectrum measuring device 203. Then, the spectrum measuring device 203 performs spectrum characteristic measuring by spectrally dispersing the test target light and measuring the light amount of light of each wavelength that has been spectrally dispersed. In other words, spectrum characteristic measuring is performed in which the test target light that is light reflected by the test target A is incident to the optical filter (etalon) 10, and the light amount of transmitted light transmitted from the optical filter 10 is measured. Then, the colorimetric control device 204 performs a colorimetric process for the test target A, that is, a process of analyzing the degrees of included colors of each specific wavelength based on the acquired the optical characteristic.

The light source device 202 includes a light source 210 and a plurality of lenses 212 (only one is illustrated in FIG. 10) and emits white light for the test target A. In addition, in the plurality of lenses 212, a collimator lens is included, and the light source device 202 forms the white light emitted from the light source 210 to be parallel light by using the collimator lens and emits the parallel light from a projection lens, which is not shown in the figure, toward the test target A.

The spectrum measuring device 203, as shown in FIG. 10, includes an optical filter 10, a light receiving unit 220 including a light receiving element, a driving circuit 230, and a control circuit unit 240. In addition, the spectrum measuring device 203 includes an incident optical lens, which is not illustrated in the figure, that guides the light (measurement target light) reflected by the test target A to the inside at a position facing the optical filter 10.

The light receiving unit 220 is configured by a plurality of photoelectric conversion elements (light receiving elements) and generates an electric signal according to the amount of received light. In addition, the light receiving unit 220 is connected to the control circuit unit 240 and outputs the generated electric signal to the control circuit unit 240 as a light reception signal. Furthermore, an optical filter module may be configured by forming the optical filter 10 and the light receiving unit (light receiving element) 220 as a unit.

The driving circuit 230 is connected to the lower electrode 60 and the upper electrode 70 of the optical filter 10 and the control circuit unit 240. This driving circuit 230 applies a driving voltage between the lower electrode 60 and the upper electrode 70 based on a driving control signal input from the control circuit unit 240, thereby moving the second substrate 30 to a predetermined displaced position. The driving voltage may be applied such that a desired electric potential is generated between the lower electrode 60 and the upper electrode 70, and, for example, it maybe configured such that a predetermined voltage is applied to the lower electrode 60, and the upper electrode 70 is set to the earth electric potential. It is preferable to use a direct current as the driving voltage.

The control circuit unit 240 controls the overall operation of the spectrum measuring device 203. This control circuit unit 240, as shown in FIG. 10, is configured by, for example, a CPU 250, a storage unit 260, and the like. The CPU 250 performs a spectrum measuring process based on various programs and various kinds of data stored in the storage unit 260. The storage unit 260 is configured to include a recoding medium such as a memory or a hard disk and stores various programs, various kinds of data, and the like so as to be able to be appropriately read out.

Here, in the storage unit 260, as programs, a voltage adjusting section 261, a gap measuring section 262, a light amount recognizing section 263, and a measurement section 264 are stored. In addition, the gap measuring section 262 may be omitted as described above.

In the storage unit 260, the voltage table data 265 shown in FIG. 6 is stored in which voltage values applied to the electrostatic actuators 80 and 90 so as to adjust the gap of the first gap G1 and the time for which each voltage value is applied are associated with each other.

The colorimetric control device 204 is connected to the spectrum measuring device 203 and the light source device 202 and performs the control of the light source device 202 and a colorimetric process that is based on the spectrum characteristic that is acquired by the spectrum analyzing device 203. As the colorimetric control device 204, for example, a general-purpose personal computer, a mobile information terminal, a colorimetric dedicated computer, or the like can be used.

The colorimetric control device 204, as shown in FIG. 10, includes a light source control unit 272, a spectrum characteristic acquiring unit 270, a colorimetric processing unit 271, and the like.

The light source control unit 272 is connected to the light source device 202. In addition, the light source control unit 272 outputs a predetermined control signal to the light source device 202, for example, based on a setting input from a user and emits white light of predetermined brightness from the light source device 202.

The spectrum characteristic acquiring unit 270 is connected to the spectrum measuring device 203 and acquires a spectrum characteristic input from the spectrum measuring device 203.

The colorimetric processing unit 271 performs a colorimetric process in which the chromaticity of the test target A is measured based on the spectrum characteristic. For example, the colorimetric processing unit 271 forms the optical characteristic acquired from the spectrum measuring device 203 as a graph and performs a process of outputting the graph to an output device such as a printer, a display, or the like not shown in the figure or the like.

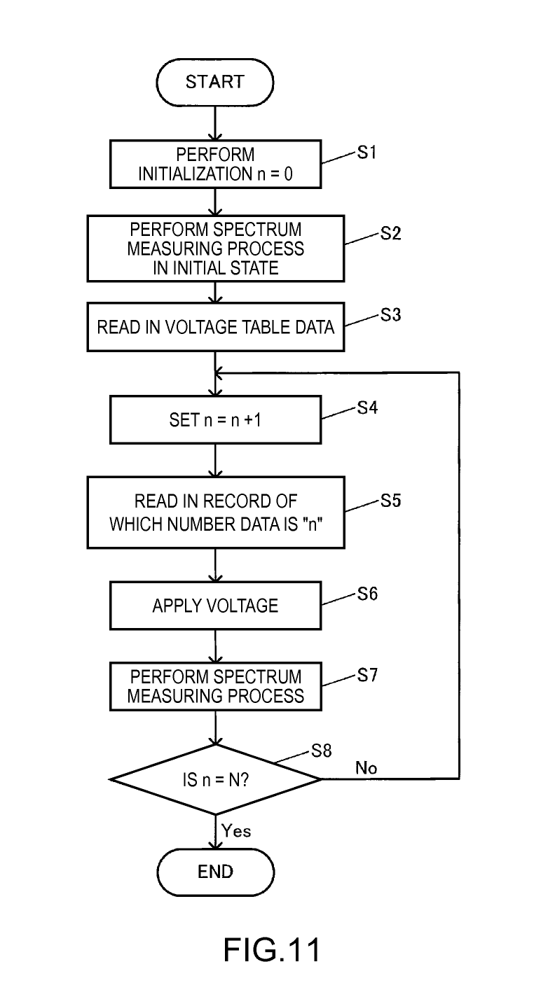

FIG. 11 is a flowchart illustrating a spectrum measuring operation of the spectrum measuring device 203. First, the CPU 250 of the control circuit unit 240 starts up the voltage adjusting section 261, the light amount recognizing section 263, and the measurement section 264. In addition, the CPU 250 initializes a measurement count variable n (set n=0) as the initial state (Step 51). In addition, the measurement variable n has an integer value equal to or greater than 0.

Thereafter, the measurement section 264 measures the light amount of light transmitted through the optical filter 10 in the initial state, that is, the state in which no voltages are applied to the electrostatic actuators 80 and 90 (Step S2). In addition, the size of the first gap G1 in the initial state may be measured in advance at the time of manufacturing the spectrum measuring device and stored in the storage unit 260. Then, the measurement section 264 outputs the light amount of transmitted light in the initial state, which has been acquired here, and the size of the first gap G1 to the colorimetric control device 204.

Next, the voltage adjusting section 261 reads in the voltage table data 265 stored in the storage unit 260 (Step S3). In addition, the voltage adjusting section 261 adds “1” to the measurement count n (Step S4).

Thereafter, the voltage adjusting section 261 acquires the voltage data and the voltage application period data of the first and second fixed electrodes 62 and 64 corresponding to the measurement count n from the voltage table data 265 (Step S5). Then, the voltage adjusting section 261 outputs a driving control signal to the driving circuit 230 and performs the process of driving the electrostatic actuators 80 and 90 according to the data of the voltage table data 265 (Step S6).

In addition, the measurement section 264 performs the spectrum measuring process at timing when the application time elapses (Step S7). In other words, the measurement section 264 allows the light amount recognizing section 263 to measure the light amount of the transmitted light. In addition, the measurement section 264 performs control so as to output a light measurement result, in which the measured light amount of the transmitted light and the wavelength of the transmitted light are associated with each other, to the colorimetric control device 204. In addition, the measurement of the light amount may be performed by storing the data of light amounts for a plurality of times or all the times in the storage unit 260, acquiring the data of light amounts for the plurality of times or the data of all the light amounts, and summarizing the acquired data.

Thereafter, the CPU 250 determines whether or not the measurement count variable n arrives at the maximum value N (Step S8) and ends a series of the spectrum measuring operations in a case where the measurement count variable n is N. On the other hand, in a case where the measurement count variable n is less then N in Step S8, the process is returned to Step S4, the process of adding “1” to the measurement count variable n is performed, and the process of Steps S5 to S8 is repeated.

### 4. Optical Device

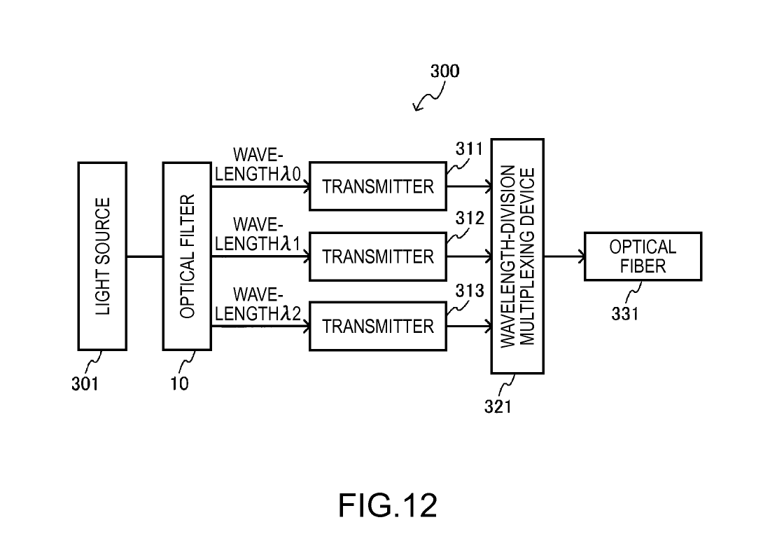

FIG. 12 is a block diagram showing a schematic configuration of a transmitter of a wavelength-division multiplexing communication system as an example of an optical device according to an embodiment of the invention. In the wavelength-division multiplexing (WDM) communication, a characteristic in which signals having different wavelengths do not interfere with each other is used, and by using a plurality of optical signals having different wavelengths in a multiplexing manner inside one optical fiber, the amount of data transmission can be improved without increasing the number of the optical fiber lines.

As shown in FIG. 12, the wavelength-division multiplexing transmitter 300 includes an optical filter 10 to which light is incident from a light source 301, and light having a plurality of wavelengths λ0, λ1, λ2, . . . is transmitted from the optical filter 10. In addition, transmitters 311, 312, and 313 are disposed for each wavelength. The optical pulse signals corresponding to a plurality of channels that are transmitted from the transmitters 311, 312, and 313 are combined to one by a wavelength-division multiplexing device 321, and the combined signal is transmitted to one optical fiber transmission line 331.

The invention can be similarly applied to an optical code-division multiplexing (OCDM) transmitter. The reason for this is that, in the OCDM, a channel is identified through pattern matching of an encoded optical pulse signal, and an optical pulse configuring the optical pulse signal includes optical components of mutually different wavelengths.

Although several embodiments have been described, it can be easily understood to those skilled in the art that various modifications not substantially departing from the spirit and advantages of the invention can be made. Accordingly, such modified examples are within the scope of the invention. For example, in the description and the drawings, a term that is written together with another term having a broader meaning or the same meaning may be substituted by the another term in any other place in the description, claims or drawings.

This application claims priority to Japanese Patent Application No. 2011-022449 filed Feb. 4, 2011 which is hereby expressly incorporated by reference herein in its entirety.

What is claimed is:

1. An optical filter comprising:
a first substrate;
a second substrate that faces the first substrate;
a first reflective film that is disposed on the first substrate;
a second reflective film that is disposed on the second substrate and that faces the first reflective film;
a first fixed electrode that is disposed on the first substrate and is formed at a periphery of the first reflective film in plan view;
a second fixed electrode that is disposed on the first substrate and is formed at a periphery of the first fixed electrode in plan view;
a lead-out wiring that is connected to the first fixed electrode and extends away from the first reflective film;
a first variable electrode that is disposed on the second substrate and that faces the first fixed electrode; and
a second variable electrode that is disposed on the second substrate and that faces the second fixed electrode,
wherein the second variable electrode includes a plurality of slit portions, and the second variable electrode has a center-symmetrical structure with the reflective film as its center, and
wherein the lead-out wiring passes through the slit portion in plan view.

2. The optical filter according to claim 1, wherein a third variable electrode is disposed on an outer-circumferential side of the second variable electrode, the third variable electrode has center symmetry with the reflective film as its center, and has slit portions numbering at least equal to the slit portions of the second variable electrode.

3. The optical filter according to claim 1, wherein the first fixed electrode and the second fixed electrode are electrically independent of each other, and the first variable electrode and the second variable electrode are electrically connected to each other through a connection portion.

4. An optical filter module comprising:
the optical filter according to claim 1; and
a light receiving element that receives light transmitted through the optical filter.

5. An analysis device comprising:
the optical filter according to claim 1.

6. An analysis device comprising:
the optical filter according to claim 1,
a light source device, and
a colorimetric control device.

7. An optical device comprising:
the optical filter according to claim 1.

8. An optical filter comprising:
a first substrate; and
a second substrate that faces the first substrate;
wherein the first substrate includes:
a first reflective film;
a first fixed electrode that is formed at a periphery of the first reflective film;
a second fixed electrode that is formed at a periphery of the first fixed electrode in plan view; and
a lead-out wiring that is connected to the first fixed electrode and extends away from the first reflective film;
wherein the second substrate includes:
a movable portion;
a holding portion that movably holds the movable portion so that the movable portion selectively advances or retreats with respect to the first substrate;
a second reflective film that is disposed on the movable portion and that faces the first reflective film across a gap;
a first variable electrode that is disposed so as to face the first fixed electrode; and
a second variable electrode that is disposed so as to face the second fixed electrode,
wherein the second variable electrode includes a plurality of slit portions, and the second variable electrode has a rotationally symmetric structure, and
wherein the lead-out wiring passes through the slit portion in plan view.
